(19) United States
(12) Patent Application Publication
(10) Pub. No.: US 2013/0175409 A1
(43) Pub. Date: Jul. 11, 2013

(54) MOUNTING BAR

(71) Applicants: James R. Hennessey, West Hartford, CT (US); James Robinson, Wolcott, CT (US)

(72) Inventors: James R. Hennessey, West Hartford, CT (US); James Robinson, Wolcott, CT (US)

(21) Appl. No.: 13/344,946

(22) Filed: Jan. 6, 2012

(51) Int. Cl. F16L 3/10; F16L 3/08

(52) U.S. Cl. 248/74.1

(57) ABSTRACT

A mounting bar has a body portion and a mounting slot extending at least part way through the body portion near an end thereof. The mounting slot is defined by a first radius extending through the body portion. The slot is further defined by a bottom surface substantially tangent to the first radius, the bottom surface extending toward the end of the body portion. A leading surface, closer to the end of the body portion than the first radius, extends from the bottom surface of the slot to an outside surface of the body portion. A clamping mechanism is provided and is operable to secure the mounting bar to another support that is positioned in the mounting slot.

### TECHNICAL FIELD

The present invention is directed in general to equipment for mounting devices and, more particularly, to a mounting bar resistant to slipping under load, the mounting bar capable of being used with existing support structures to mount various equipment or devices.

### BACKGROUND

Conventional systems for adjustably mounting and supporting various devices generally employ clamping mechanisms. Such clamping mechanisms generally mount and support the devices in a limited number of positions. Vibration or jarring of any portion of the system or the supported device, however, may cause the clamping mechanism to loosen, thereby causing undesirable slippage and movement of the mounted device. In addition, sometimes such clamping devices inadequately grip whatever they are mounted to causing the device to slip.

### SUMMARY

In one aspect, the present invention resides in a mounting bar having a body portion and a mounting slot extending at least part way through the body portion near an end thereof. The mounting slot is defined by a first radius extending through the body portion. The slot is further defined by a bottom surface substantially tangent to the first radius, the bottom surface extending toward the end of the body portion. A leading surface, closer to the end of the body portion than the first radius, extends from the bottom surface of the slot to an outside surface of the body portion. A clamping mechanism is provided and is operable to secure the mounting bar to another support that is positioned in the mounting slot. The other support can form part of, but is not limited to, a microphone stand, a light stand, a shopping cart, wheelchair, drum hardware, exercise equipment, or the like.

The leading surface can define, at least in part, a second radius substantially tangent to the bottom surface. The centerline of the second radius is offset from a centerline defined by the first radius by the above-described bottom surface. The offset is sized to allow for easy insertion of the other support into the mounting slot.

The slot can also be angled to allow the mounting bar to extend from whatever it is mounted to at a desire angle.

In one embodiment, the body portion of the mounting bar includes a first body portion and a second body portion, the first and second body portions being selectively rotatable relative to one another. The first and second body portions once rotated to a desired location relative to one another can be retained in position via a retention mechanism. The retention mechanism includes an outer gear coupled to one of the first and second body portions and an inner gear coupled to the other of the first and second body portions, the inner gear being matingly engageable with the outer gear. A spring assembly urges the first and second body portions toward one another, thereby allowing the inner and outer gears to remain meshed with one another. When the first and second body portions are to be rotated relative to one another, the first and second body portions are pulled away from each other, causing the inner and outer gears to disengage. The first and second body portions are then rotated relative to one another and the teeth defining the inner and outer gears are meshed back together, releasably fixing the position of the first and second body portions. A sleeve can be provided and extends part way along the first and second body portions to provide support thereto in an area where the first and second body portions pull away from each other.

### BRIEF DESCRIPTION OF THE DRAWINGS

FIG. 1A is an exploded perspective view of a bar for mounting a device, in accordance with the present invention.

FIG. 1B is an exploded perspective view of an alternate embodiment of a bar for mounting a device, of the present invention.

FIG. 1C is a side sectional view of the bar of FIG. 1B.

FIG. 2 is a top sectional view of a bar for mounting a device, in accordance with the present invention, in which the bar is bent.

FIG. 3 is a side view of the bar of FIG. 1A.

FIG. 4 is a top view of the bar of FIG. 1A.

FIG. 5 is a side sectional view of an alternate embodiment of a two-piece bar for mounting a device, in accordance with the present invention, the two pieces of the bar being axially engaged.

FIG. 6 is a perspective view of the two-piece bar of FIG. 5 having a splined assembly with sleeves.

FIG. 7 is a side sectional view of the two-piece bar of FIG. 5, the two pieces of the bar being axially disengaged.

FIG. 8 is a perspective view of an alternate embodiment of the bar, in accordance with the present invention, defined by a sleeve.

FIG. 9 is a side sectional view of the bar of FIG. 8.

### DETAILED DESCRIPTION

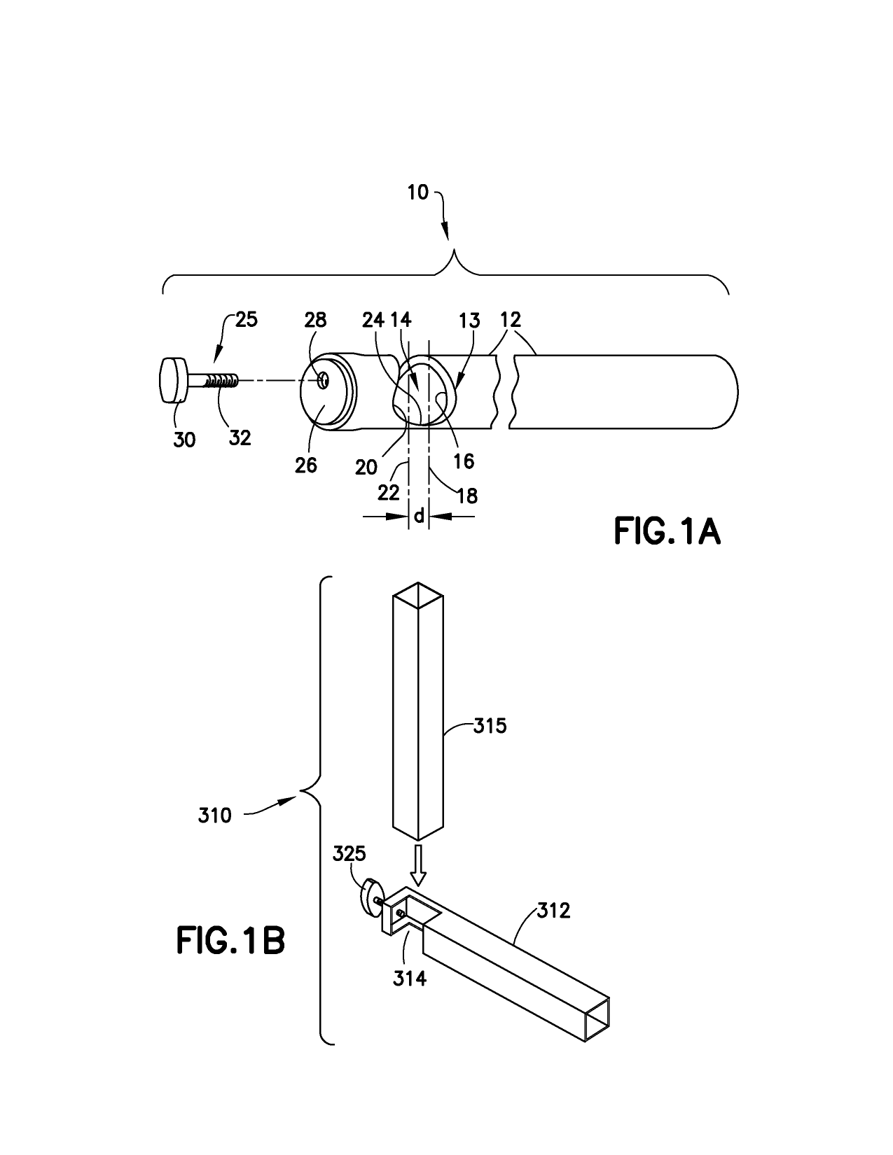

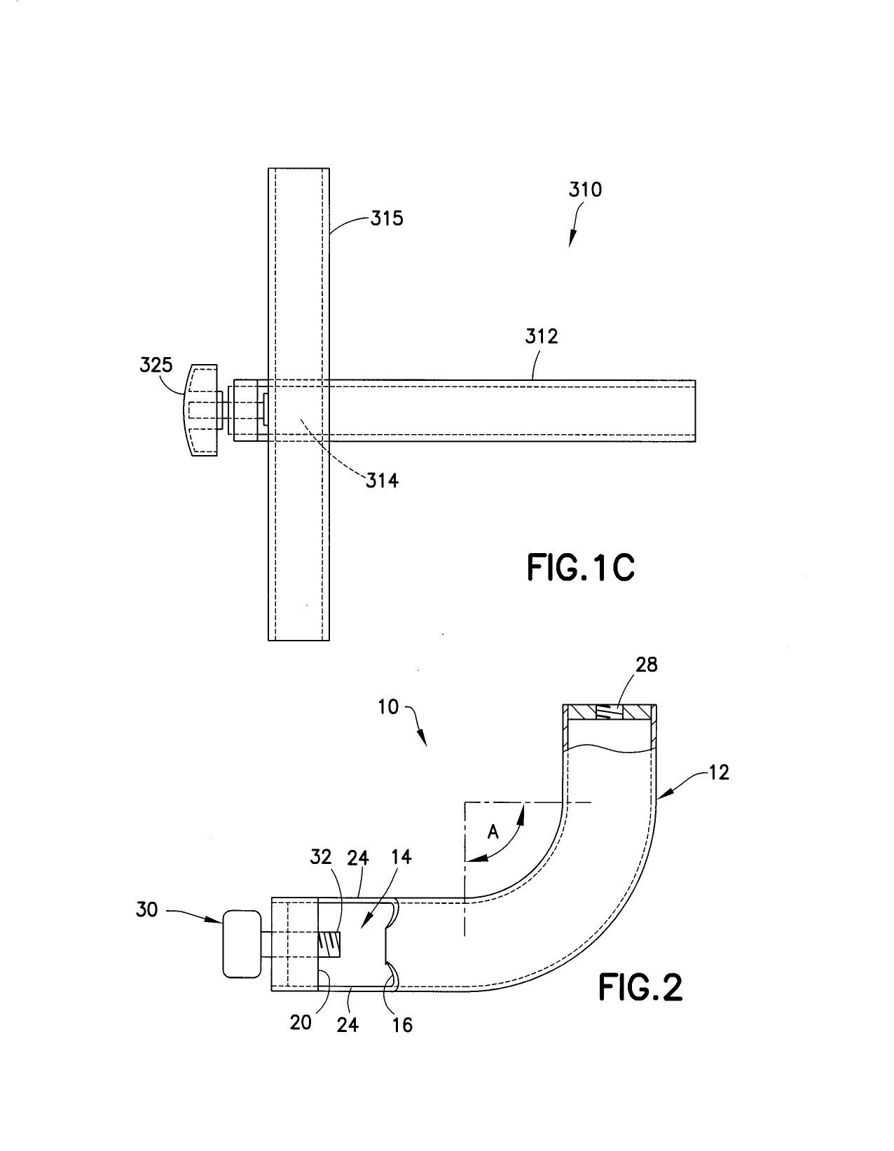

As shown in FIG. 1A, a mounting bar generally designated by the reference number 10 includes a body portion 12 defining a slot 14 adjacent an end of the body portion. The slot 14, as shown in the illustrated embodiment, comprises an end portion 13 defined by first radius 16. The first radius 16 is also defined in part by a first centerline 18. A second end portion 19 is defined by a second radius 20. The second radius 20 is defined in part by a second centerline 22. In the illustrated embodiment, the first and second centerlines, 18 and 22 respectively, are separated by a distance designated by the reference letter “d.” The size of the first radius 16 and the length of the distance “d” is dependent on the size of the mounting bar 10 as well as the size of the bar, tube, or other item that the mounting bar can be attached to. In the illustrated embodiment, the first radius 16 is tangent to a bottom surface 24 defined by the slot 14. While a second radius has been described, the present invention is not limited in this regard as there can be instances where there is no second radius, but rather a substantially straight wall portion defined in part by a right angle, or square corner, or other angle is employed without departing from the broader aspects of the present invention.

In the illustrated embodiment, the mounting bar is hollow and an end cap 26 is positioned in the body portion 12 to accommodate a clamping mechanism 25. The end cap 26 defines a threaded hole 28 extending through the end cap. The clamping mechanism 25 comprises a knob 30 that includes a threaded shaft 32 extending outwardly therefrom. The threaded shaft 32 is threadably engageable with the threaded hole 28 and, as will be explained in greater detail below, engages and causes the item to which the mounting bar is being coupled to engage the first end portion 13. The present invention is not limited to the clamping mechanism comprising a knob 30 on a threaded shaft 32 engageable with a threaded hole 28, however, as other mechanisms may be employed. For example, the clamping mechanism 25 can be a toggle clamp, ball detent, spring loaded piston, or the like. While the body portion 12 of the mounting bar 10 has been described as being hollow, the present invention is not limited in this regard as the body portion can also be solid. In such a case, the end cap 26 would not be needed and the threaded hole 28 could be defined by the body portion 12 to allow a threaded knob to be inserted therein.

As shown in FIGS. 1B and 1C, a mounting bar generally designated by the reference number 310 includes a body portion 312 defining a slot 314 adjacent an end of the body portion. The body portion 312 is cut or otherwise formed such that the slot 314 is defined by substantially straight wall portions defined in part by right angles and square corners. As illustrated in FIG. 1B, the slot 314 is capable of receiving a bar or tube 315 similarly configured (straight wall portions defined in part by right angles and square corners, the straight wall portions being complementary to the wall portions of the slot 314). A clamping mechanism 325 (similar to clamping mechanism 25 described above) is positioned in an end of the body portion 312 to urge the tube 315 against at least one wall defining the slot 314 to releasably clamp the tube into the slot 314, as illustrated in FIG. 1C.

The body portion 12 is not limited to being straight, as shown in FIGS. 1A, 1B, and 1C. Referring to FIG. 2, the body portion 12 may include a suitable bend at any desired angle A. As shown, angle A is 90 degrees. The present invention is not limited to the body portion 12 being either straight or angled at 90 degrees, however, as the body portion can be any combination of straight tubing and bent tubing. Furthermore, although the tubing is illustrated herein as having a round cross-sectional geometry and an angular (rectangular) cross-sectional geometry, the present invention is not so limited, as the tubing can have a cross-sectional geometry that is elliptical or any other shape.

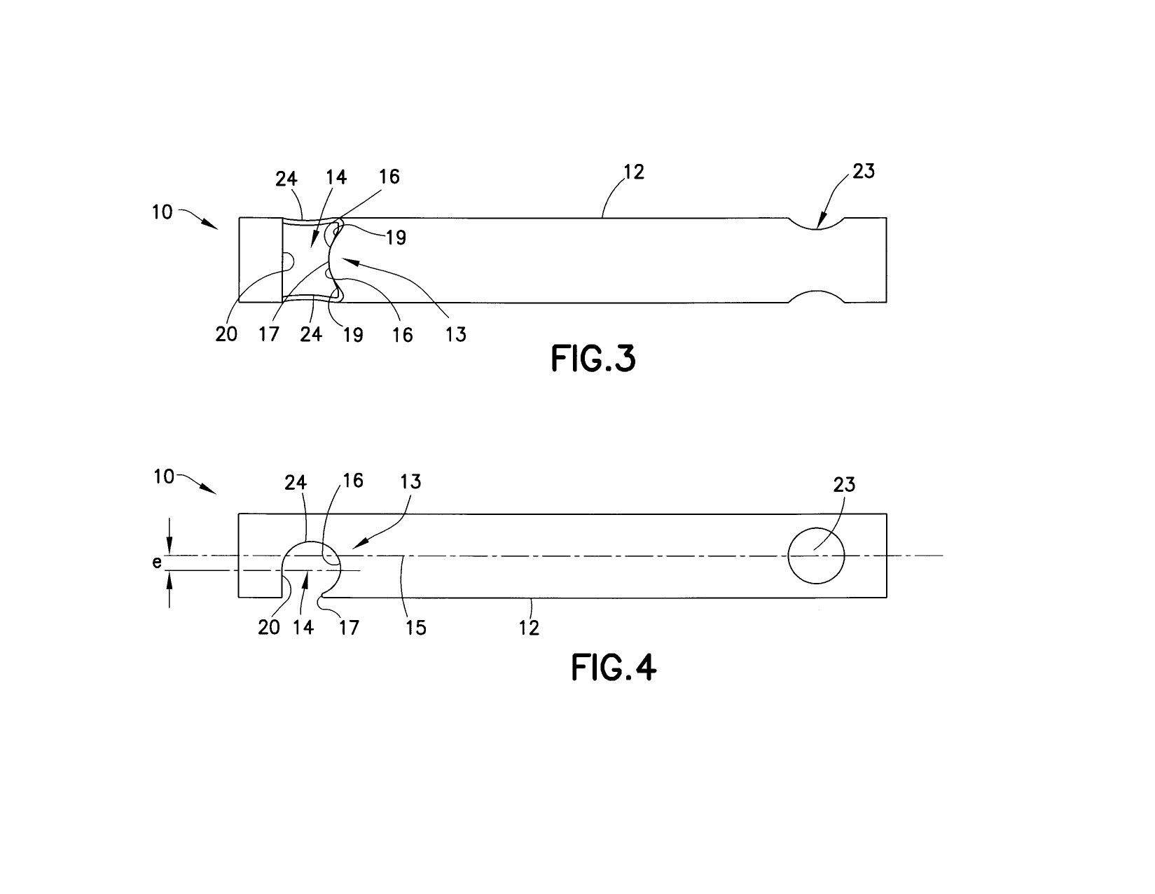

Referring to FIGS. 3 and 4, the first radius 16 is defined by a leading edge 17 and two bearing edges 19. The leading edge 17 and the two bearing edges 19 are positioned to define the slot 14 such that the center point of the slot 14 is offset from a centerline 15 extending longitudinally through the mounting bar 10 by a distance “e” (FIG. 4). At least the two bearing edges 19 define elliptically enveloping surfaces that make contact with a matingly-shaped item (“the item”) received in the slot 14. In offsetting the slot 14 by the distance “e,” a suitable amount of material remains on the body portion 12 in the area surrounding the slot to enable the item to be supported. Upon operating the clamping mechanism 25 as shown by turning the threaded shaft 32 to cause the translation thereof through the threaded hole 28, the item positioned in the slot 14 is urged against the bearing edges 19 and elliptically enveloped such that the contact of the item with the bearing edges holds the item in place. The leading edge 17 further aids in releasably locking the item against the bearing edges 19. The present invention is not limited to the center point of the slot 14 being offset from the centerline 15 as shown, however, as other configurations are within the scope of the present invention.

The first radius 16 (and thus the leading edge 17 and the bearing edges 19) is sized and configured to accommodate an item having a cross-sectional dimension within a specific range and up to a particular diameter. For example, a first radius 16 in a body portion 12 having a one-inch diameter may be sized and configured to receive a second member of tubing having a cross-sectional diameter of 10-16 millimeters (mm). A first radius 16 in a body portion 12 having a larger diameter may be sized and configured to receive a second member of tubing having larger cross-sectional diameter (e.g., 17-25 mm or 26-36 mm). The present invention is not limited to the configuration as shown, however, as the slot could also be squared off to attach to a tray table or the like.

Still referring to FIGS. 3 and 4, a through hole 23 extends through the body portion 12. A clamping mechanism may be employed to secure the tubing in the through hole 23. The clamping mechanism may be a threaded shaft translatable through an end cap or a threaded hole, as is employed to secure the tubing in the slot 14.

Although both the slot 20 and the through hole 23 are shown as being configured to allow the tubing to be mounted therein perpendicular to the bar 10, the present invention is not so limited as the slot and the through hole may be angled through the body portion 12 to allow the mounting bar 10 to be located on the tubing (e.g., shaft of a microphone stand or the like) at an angle.

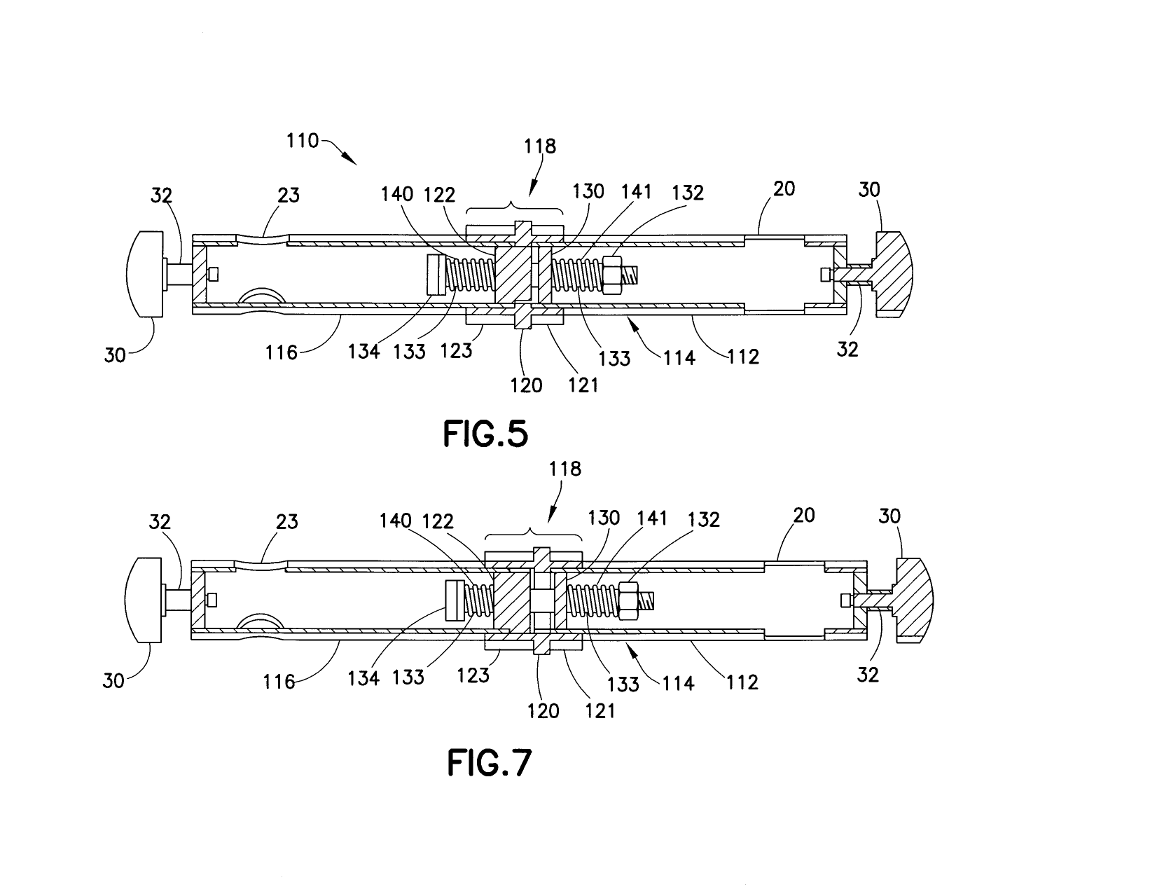

As shown in FIGS. 5-7, an alternate embodiment of the bar is designated generally by the reference number 110 and is hereinafter referred to as “bar 110.” Bar 110 comprises a body portion 112 defined by a first body portion 114 axially coupled to a second body portion 116 via a selectively-engageable splined assembly 118. The first body portion 114 includes a slot 20 as defined above with regard to FIG. 1 (and/or a through hole 23) as well as a knob 30 and a threaded shaft 32. The splined assembly 118 allows the first body portion 114 to be rotated relative to the second body portion 116, thereby allowing a device (e.g., a microphone, sheet music holder, light, or the like) mounted on the second body portion 116 to be adjustably positionable.

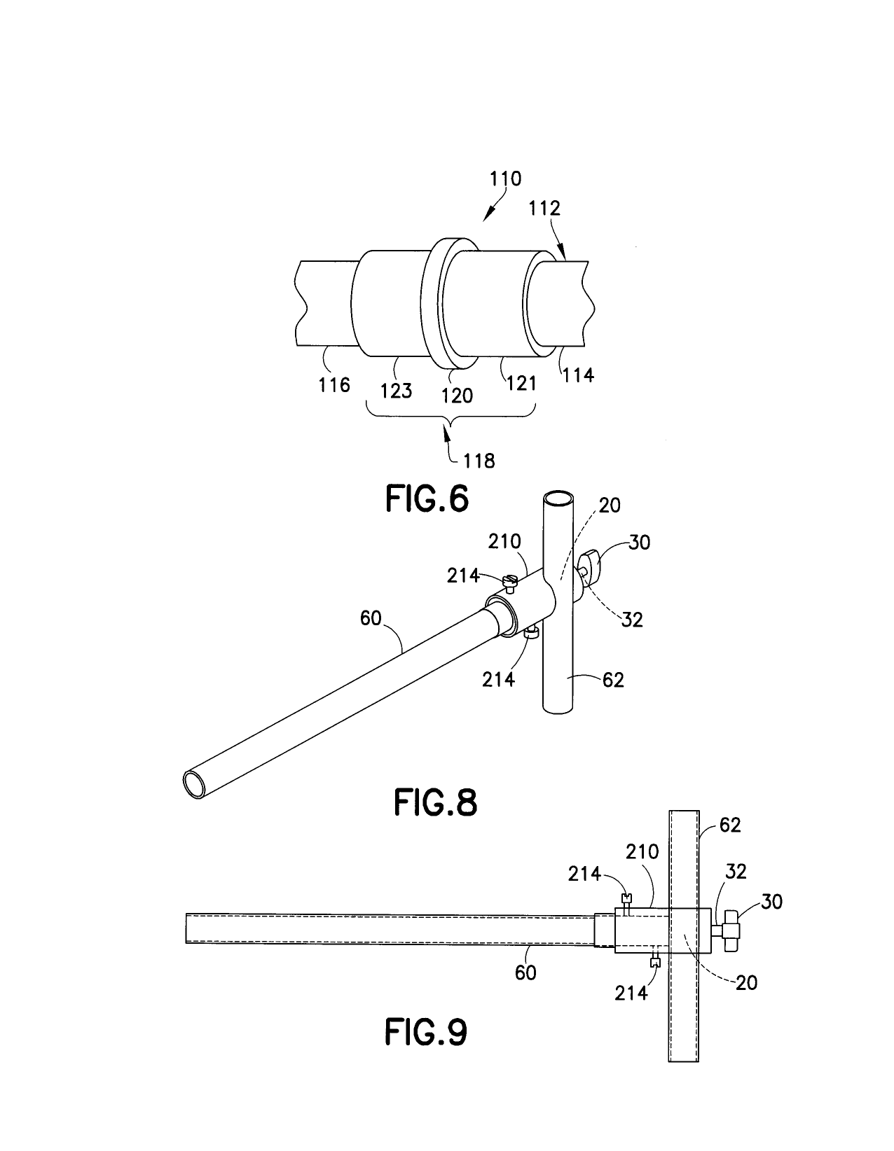

The splined assembly 118 is defined by an outer gear 120 having a first sleeve 121 extending from one side thereof over a portion of the first body portion 114 and a second sleeve 123 extending from the other side thereof in an opposing direction over a portion of the second body portion 116, as shown in FIG. 6. The first body portion 114 is received in and supported by the first sleeve 121, and the second body portion 116 is received in and supported by the second sleeve 123. The outer gear is engageable with an inner gear 122 mounted to an end of the second body portion 116 proximate the splined assembly 118, as shown in the embodiment of FIGS. 5-7. Both the outer gear 120 and the inner gear 122 are also slidably mounted to a shaft 133 coupled to the first body portion 114. The shaft 133 extends through the outer gear 120, the inner gear 122, and a spring plate 130 mounted to an end of the first body portion 114 proximate the splined assembly 118. A first spring 140 is located on the shaft 133 between a head 134 of the shaft and the inner gear 122. A second spring 141 is also located on the shaft 133 between a nut 132 threaded on an end of the shaft 133 opposite the head 133 and the spring plate 130. During operation, the first and second body portions, 114 and 116 respectively, can be pulled away from one another, thereby disengaging the inner gear 122 from the outer 120. The first and second body portions, 114 and 116 respectively, can then be rotated relative to one another. Once positioned in a desired location, the first spring 140 and the second spring 141 urge the outer and inner gears, 120 and 122, into engagement with one another, releasably fixing the position of the first and second body portions relative to one another.

As shown in FIGS. 8 and 9, the mounting bar may be defined by a short sleeve, shown at 210, appropriately sized to enable the sleeve to be slidably positioned over the end of a first tube 60 such as a horizontal bar or an upright member on a legged stand or base. The sleeve is open on one end having clamping mechanisms 214 to allow the sleeve to be secured to the first tube 60. The clamping mechanisms 214 may be finger-actuatable, as shown, or they may comprise hex head screws or the like. The knob 30 and threaded shaft 32 are located on the sleeve to allow the bar 210 to receive and clamp a second tube 62 in the slot 20. Suitable devices such as sheet music holders, microphones, lights, or the like can be mounted on the second tube 62.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the foregoing description.

What is claimed is:

1. A mounting bar, comprising:
a body portion defining a first end and a second end;
a mounting slot located in the body portion, the mounting slot having a first side portion and a second side portion; and
a clamping mechanism received in the first end of the body portion, a portion of the clamping mechanism extending into the body portion towards the first side portion of the mounting slot; and
wherein the clamping mechanism is configured to engage a tubing member positioned in the mounting slot, thereby urging the tubing member against the second side portion to releasably retain the mounting bar on the tubing member.

2. The mounting bar of claim 1, wherein the body portion is hollow and a cap is located on the first end of the body portion, the clamping mechanism defining a shaft being threadedly received through a threaded hole in the cap.

3. The mounting bar of claim 1, wherein the body portion is solid.

4. The mounting bar of claim 2, wherein the shaft has a knob located on an end thereof, and wherein a turning of the knob causes translation of the shaft relative to the first end of the body portion to push the tubing member in the mounting slot against the second side portion of the mounting slot.

5. The mounting bar of claim 1, wherein the body portion has a round cross-sectional geometry.

6. The mounting bar of claim 1, wherein the body portion is substantially straight.

7. The mounting bar of claim 1, wherein the body portion is bent at an angle.

8. The mounting bar of claim 1, wherein the mounting slot defines a center point that is offset from an axis extending longitudinally through the body portion.

9. A mounting bar, comprising:
a first body portion having a mounting slot defined therein;
a second body portion;
a selectively-engageable splined assembly coupling the first body portion to the second body portion, the selectively-engageable splined assembly comprising,
an outer gear mounted on the first body portion,
an inner gear mounted on the second body portion,
a shaft extending through the outer gear and the inner gear, and
a first spring and a second spring coupling the outer gear and the inner gear and urging the outer gear and inner gear into engagement along the shaft;
wherein the selectively-engageable splined assembly allows the first body portion to be pulled away from the second body portion to disengage the outer gear from the inner gear and urged together to engage the outer gear and the inner gear.

10. The mounting bar of claim 9, further comprising a spring plate mounted on the shaft and in engagement with the inner gear, one end of the spring being coupled to the spring plate.

11. The mounting bar of claim 9, further comprising a retaining plate coupled to the first body portion and the shaft being coupled for rotation to the retaining plate.

12. The mounting bar of claim 9, wherein the mounting slot located in the first body portion is defined by a first radius extending through the first body portion, a bottom surface substantially tangent to the first radius, the bottom surface extending toward an end of the first body portion, and a leading surface extending from the bottom surface to an outside surface of the first body portion.

13. The mounting bar of claim 12, further comprising a clamping mechanism received in the end of the first body portion;
wherein upon engagement of the clamping mechanism and a tubing member positioned in the mounting slot, the tubing member positioned in the mounting slot is pushed against the first radius.

14. The mounting bar of claim 9, wherein the center point of the mounting slot is offset from an axis extending longitudinally through the first body portion and the second body portion.

15. The mounting bar of claim 9, wherein the selectively-engageable splined assembly comprises a first sleeve in which the first body portion is received and a second opposing sleeve in which the second body portion is received.

16. The mounting bar of claim 1, wherein:
the second end of the body portion defines a sleeve having an open end, the open end being slidably positionable over a tubing member.

17. (canceled)

18. The mounting bar of claim 16, wherein the first end of the body portion has a larger diameter than the open end of the sleeve.

19. (canceled)

20. The mounting bar of claim 1, wherein the first side portion and the second side portion of the mounting slot are substantially straight.

21. The mounting bar of claim 1, wherein:
the first side portion is defined by a first radius;
the second side portion is defined by a second radius; and
the slot defines a bottom surface having a third radius that is substantially tangent to the first radius and the second radius.
